(19) United States
(12) Patent Application Publication
(10) Pub. No.: US 2020/0379743 A1
(43) Pub. Date: Dec. 3, 2020

(54) USB-BASED METHOD AND DEVICE FOR UPGRADING ELECTRONIC APPARATUS, AND ELECTRONIC APPARATUS

(71) Applicant: Qingdao GoerTek Technology Co.,Ltd., Qingdao City (CN)

(72) Inventor: Xuemei WANG, Qingdao City (CN)

(21) Appl. No.: 16/305,702

(22) PCT Filed: Dec. 31, 2016
(86) PCT No.: PCT/CN2016/114002

§ 371 Date: Nov. 29, 2018

(30) Foreign Application Priority Data
Aug. 24, 2016 (CN) 201610717522.2

(51) Int. Cl. G06F 8/65; G06F 13/42

(52) U.S. Cl. CPC G06F 8/65; G06F 2213/0042; G06F 13/4282

(57) ABSTRACT

A method and apparatus (200) for upgrading an electronic device (400) via a USB and an electronic device (400) are provided. The method comprises: receiving an upgrade instruction (S101); controlling the electronic device (400) to switch from a normal mode to a preparing-for-upgrade mode according to the upgrade instruction (S102); detecting whether the electronic device (400) has established a connection to a computer through a USB data line (S103), and if yes, receiving an upgrade confirmation instruction sent by the computer through the USB data line (S104), and controlling the electronic device (400) to switch from the preparing-for-upgrade mode to an upgrade mode and perform upgrade (S105); and if no, controlling the electronic device (400) to switch back to the normal mode from the preparing-for-upgrade mode (S106).

### CROSS REFERENCE TO RELATED APPLICATIONS

This application is a U.S. National Stage entry under 35 U.S.C. § 371 based on International Application No. PCT/CN2016/114002, filed on Dec. 31, 2016, which was published under PCT Article 21(2) and which claims priority to Chinese Patent Application No. 201610717522.2, filed on Aug. 24, 2016. These applications are hereby incorporated herein in their entirety by reference.

### TECHNICAL FIELD

This Application pertains to the technical field of software upgrading, and more particularly, to a method and apparatus for upgrading an electronic device via a USB and an electronic device.

### BACKGROUND

Many existing electronic devices have a USB interface, and they may be connected to a computer via the USB interface to upgrade the system software. The user may send an instruction through a button on the electronic device or a computer terminal to control the upgrade of the electronic device. Once receiving the upgrade instruction, the electronic device will enter the upgrade mode, and cannot exit until the upgrade is completed. If the user enters the upgrade mode by mistakenly operating the button, he may not be able to exit.

In addition, other objects, desirable features and characteristics will become apparent from the subsequent summary and detailed description, and the appended claims, taken in conjunction with the accompanying drawings and this background.

### SUMMARY

According to a first aspect of the present disclosure, there is provided a method for upgrading an electronic device via a USB, comprising:

receiving an upgrade instruction;

controlling the electronic device to switch from a normal mode to a preparing-for-upgrade mode according to the upgrade instruction;

detecting whether the electronic device has established a connection to a computer through a USB data line, and if yes, receiving an upgrade confirmation instruction sent by the computer through the USB data line, and controlling the electronic device to switch from the preparing-for-upgrade mode to an upgrade mode and perform upgrade; and if no, controlling the electronic device to switch back to the normal mode from the preparing-for-upgrade mode.

Optionally, the step of controlling the electronic device to switch from the preparing-for-upgrade mode to an upgrade mode and perform upgrade comprises:

controlling the electronic device to download upgrade data through the USB data line; and

upgrading the electronic device according to the completely downloaded upgrade data.

Optionally, after the step of upgrading the electronic device according to the completely downloaded upgrade data, the method further comprises:

controlling the electronic device to switch back to the normal mode from the upgrade mode.

Optionally, the method further comprises:

in the process of downloading upgrade data through the USB data line, detecting whether the electronic device is establishing a connection to the computer through a USB data line, and if no, pausing the downloading.

According to a second aspect of the present disclosure, there is provided an apparatus for upgrading an electronic device via a USB, comprising:

a first receiving module for receiving an upgrade instruction;

a first controlling module for controlling the electronic device to switch from a normal mode to a preparing-for-upgrade mode according to the upgrade instruction;

a first detecting module for detecting whether the electronic device has established a connection to a computer through a USB data line;

a second receiving module for receiving an upgrade confirmation instruction sent by the computer through the USB data line when the electronic device has established a connection to a computer through a USB data line;

a second controlling module for controlling the electronic device to switch from the preparing-for-upgrade mode to an upgrade mode and perform upgrade after the second receiving module receives the upgrade confirmation instruction; and

a third controlling module for controlling the electronic device to switch back to the normal mode from the preparing-for-upgrade mode when the electronic device does not establish a connection to a computer through a USB data line.

Optionally, the second controlling module comprises:

a downloading unit for controlling the electronic device to download upgrade data through the USB data line; and

an upgrading unit for upgrading the electronic device according to the upgrade data completely downloaded by the downloading unit.

Optionally, the apparatus further comprises a fourth controlling module for, after upgrading the electronic device by the upgrading unit, controlling the electronic device to switch back to the normal mode from the upgrade mode.

Optionally, the apparatus further comprises a second detecting module for, in the process that the downloading unit controls the electronic device to download upgrade data through the USB data line, detecting whether the electronic device is establishing a connection to the computer through a USB data line, and if no, pausing the downloading.

According to a third aspect of the present disclosure, there is provided an electronic device comprising the apparatus for upgrading an electronic device via a USB as described above.

According to a fourth aspect of the present disclosure, there is provided an electronic device comprising a memory for storing instructions and a processor for operating the instructions to implement the method for upgrading an electronic device via a USB as described above.

Other features and the advantages of the present disclosure will be apparent from the following detailed description of the exemplary embodiments of the present disclosure in conjunction with the accompanying drawings.

### BRIEF DESCRIPTION OF DRAWINGS

The present invention will hereinafter be described in conjunction with the following drawing figures, wherein like numerals denote like elements, and:

FIG. 1 is a flow chart of a method for upgrading an electronic device via a USB according to an exemplary embodiment of the present disclosure;

FIG. 2 is a principle block diagram of an apparatus for upgrading an electronic device via a USB according to an exemplary embodiment of the present disclosure;

FIG. 3 is a principle block diagram of an apparatus for upgrading an electronic device via a USB according to another exemplary embodiment of the present disclosure; and

FIG. 4 is a principle block diagram of an electronic device according to an exemplary embodiment of the present disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

The inventors of the present disclosure find that in the prior art there is a problem that the user cannot exit the upgrade mode if entering the upgrade mode by mistakenly operating the button. In the embodiments of the present disclosure, when having exited the normal mode due to a misoperation, the user can return to the normal mode by disconnecting the USB data line between the electronic device and the computer in the preparing-for-upgrade mode, thereby providing users who do not intend to upgrade an option to easily exit the upgrade mode, and effectively avoiding the problem of being unable to exit when entering the upgrade mode due to a misoperation.

Here, various exemplary embodiments of the present disclosure will be described in detail with reference to the drawings. It should be noted that, unless specified otherwise, the arrangements of the members and steps, and the mathematical formulas and numerical values described in these embodiments do not restrict the scope of the present disclosure.

The following description for at least one exemplary embodiment is actually descriptive only, and should not be intended to limit the present disclosure and any application or use thereof.

The techniques, methods and devices well known to those skilled in the related arts may not be discussed in detail. However, where applicable, such techniques, methods and devices should be deemed as part of the description.

Any specific value in all of the examples shown and discussed herein should be interpreted as illustrative only rather than restrictive. Therefore, other examples of the exemplary embodiments may include different values.

It should be noted that similar reference signs and letters in the following drawings represent similar items. Therefore, once defined in one drawing, an item is not required to be further discussed in the following drawings.

In order to solve the problem in the prior art that the user cannot exit the upgrade mode if entering the upgrade mode by mistakenly operating the button, the present disclosure provides a method for upgrading an electronic device via a USB, which allows the user who does not intend to upgrade to exit the upgrade mode easily, and improves the stability of the USB upgrade, thereby improving the user experience.

FIG. 1 is a flow chart of a method for upgrading an electronic device via a USB according to an embodiment of the present disclosure.

As shown in FIG. 1, the method comprises the following steps:

Step S101, receiving an upgrade instruction.

The upgrade instruction may be sent by a computer connected to the electronic device, or may be sent when the upgrade button is pressed.

Step S102, controlling the electronic device to switch from a normal mode to a preparing-for-upgrade mode.

The normal mode of the electronic device specifically refers to a mode in which the user can perform normal operations on the electronic device. The normal operations may be, for example, but not limited to, opening an application, switching a display interface, returning to a main interface, etc. In the normal mode, the electronic device can be normally turned on. The electronic device in the off-state may be turned on by pressing the power button, and when the electronic device is in the normal mode, that is, enters the normal existing system, the user can normally use the existing system of the electronic device.

When the electronic device is in the preparing-for-upgrade mode, the user will not be able to perform normal operations on the electronic device, but the electronic device has not started to upgrade yet.

Step S103, detecting whether the electronic device has established a connection to a computer through a USB data line, and If yes, executing step S104; and if no, executing step S106.

Step S104, receiving an upgrade confirmation instruction sent by the computer.

When the electronic device is in the preparing-for-upgrade mode, if it is detected that the electronic device has established a connection to a computer through a USB data line, an upgrade confirmation instruction sent by the computer will be received. The upgrade confirmation instruction may be sent, for example, when the computer detects that the user clicks on a corresponding button in the upgrade software installed in the computer.

Step S105, controlling the electronic device to switch from the preparing-for-upgrade mode to an upgrade mode and perform upgrade.

When the electronic device is in the upgrade mode, the system will be upgraded, and during this process, the user will not be able to perform any operation on the electronic device.

Specifically, the step of controlling the electronic device to switch from the preparing-for-upgrade mode to an upgrade mode and perform upgrade comprises: controlling the electronic device to download upgrade data through the USB data line; and upgrading the electronic device according to the completely downloaded upgrade data.

The upgrade data is a file installation package for updating the electronic device system, and the electronic device will not be upgraded based on the downloaded upgrade data until the downloading of the upgrade data is completed.

In a specific embodiment of the present disclosure, the method further comprises: in the process of downloading upgrade data through the USB data line, detecting whether the electronic device has established a connection to the computer through a USB data line, and if yes, continuing the downloading, and not performing other operations; and if no, pausing the downloading. The electronic device cannot be used until it is re-detected that the electronic device has established a connection to a computer through a USB data line. After it is re-detected that the electronic device has established a connection to a computer through a USB data line, the downloading of the upgrade data continues again, and subsequent steps are executed.

When the electronic device is upgraded according to the completely downloaded upgrade data, since the upgrade data have been downloaded completely, the upgrade process of the electronic device can be completed by itself without being connected to a computer. Thus, even if it is detected that the electronic device does not establish a connection to a computer through a USB data line, the upgrade process will not be affected and can continue.

Further, when the upgrading of the electronic device ends, the electronic device is controlled to switch back to the normal mode from the upgrade mode. When the electronic device switches back to the normal mode, the upgraded system will be opened, and the user can normally use the upgraded system.

Step S106, controlling the electronic device to switch back to the normal mode from the preparing-for-upgrade mode.

If in the preparing-for-upgrade mode, it is detected that the electronic device does not established a connection to a computer through a USB data line, the upgrade instruction received in step S101 may be considered as a misoperation instruction, and thus the electronic device may be controlled to switch back to the normal mode from the preparing-for-upgrade mode, so that the user can normally open the existing system in the electronic device.

Thus, by adding the preparing-for-upgrade mode, when having exited the normal mode due to a misoperation, the user can return to the normal mode by disconnecting the USB data line between the electronic device and the computer in the preparing-for-upgrade mode, thereby providing users who do not intend to upgrade an option to easily exit the upgrade mode, and effectively avoiding the problem of being unable to exit when entering the upgrade mode due to a misoperation. Moreover, in the upgrade mode, the electronic device must wait till the upgrade is completed before returning to the normal mode and being normally used by the user, thereby ensuring the integrity of the electronic device system program, improving the stability of upgrading the electronic device via a USB, and thus improving the user experience.

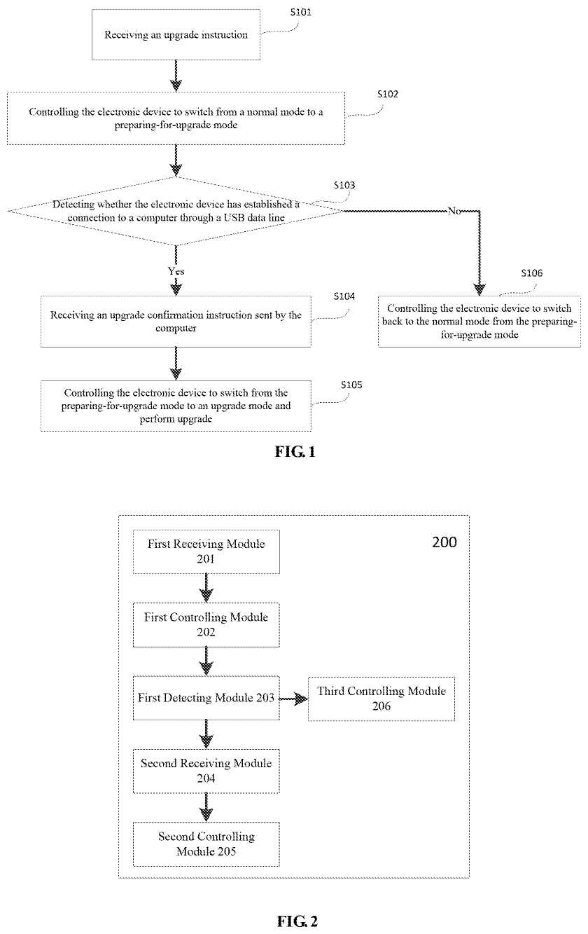

Corresponding to the above method, the present disclosure also provides an apparatus for upgrading an electronic device via a USB, the principle block diagram of which is shown in FIG. 2.

As shown in FIG. 2, the apparatus 200 comprises a first receiving module 201, a first controlling module 202, a first detecting module 203, a second receiving module 204, a second controlling module 205, and a third controlling module 206.

The first receiving module 201 is for receiving an upgrade instruction.

The first controlling module 202 is for controlling the electronic device to switch from a normal mode to a preparing-for-upgrade mode according to the upgrade instruction received by the first receiving module 201.

The first detecting module 203 is for detecting whether the electronic device has established a connection to a computer through a USB data line.

The second receiving module 204 is for receiving an upgrade confirmation instruction sent by the computer through the USB data line when the electronic device has established a connection to a computer through a USB data line.

The second controlling module 205 is for controlling the electronic device to switch from the preparing-for-upgrade mode to an upgrade mode and perform upgrade after the second receiving module 204 receives the upgrade confirmation instruction sent by the computer through the USB data line.

The third controlling module 206 is for controlling the electronic device to switch back to the normal mode from the preparing-for-upgrade mode when the electronic device does not establish a connection to a computer through a USB data line.

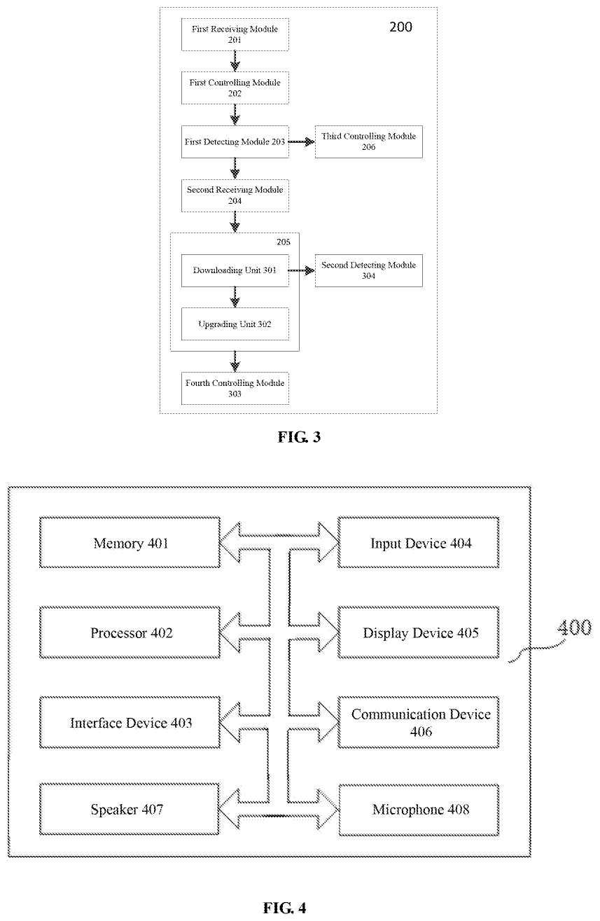

FIG. 3 is a principle block diagram of an apparatus for upgrading an electronic device via a USB according to another embodiment of the present disclosure.

As shown in FIG. 3, the second controlling module 205 further comprises a downloading unit 301 and an upgrading unit 302. The downloading unit 301 is for controlling the electronic device to download upgrade data through the USB data line. The upgrading unit 302 is for upgrading the electronic device according to the upgrade data completely downloaded by the downloading unit 301.

Further, the apparatus 200 further comprises a fourth controlling module 303 for, after upgrading the electronic device by the upgrading unit 302, controlling the electronic device to switch back to the normal mode from the upgrade mode.

On the basis of that, the apparatus 200 further comprises a second detecting module 304 for, in the process wherein the downloading unit 301 controls the electronic device to download upgrade data through the USB data line, detecting whether the electronic device establishes a connection to a computer through a USB data line, and if no, pausing the downloading; and if yes, continuing the downloading.

The present disclosure also provides an electronic device comprising the apparatus 200 for upgrading an electronic device via a USB according to the present disclosure. The electronic device may be a consumer electronic product such as a mobile phone, a tablet computer, a Bluetooth wristband, and a Bluetooth headset, etc.

FIG. 4 is a principle block diagram of an electronic device according to an embodiment of the present disclosure.

As shown in FIG. 4, the electronic device 400 comprises a memory 401 and a processor 402. The memory 401 is for storing instructions for controlling the processor 402 to operate to perform the above method for upgrading an electronic device via a USB.

In addition, as shown in FIG. 4, the electronic device 400 further comprises an interface device 403, an input device 404, a display device 405, a communication device 406, a speaker 407, a microphone 408, etc. Although a plurality of components are illustrated in FIG. 4, the present disclosure may involve only some of the components, such as the processor 402, the memory 401, the interface device 403, and the like.

The communication device 406 may communicate wiredly or wirelessly.

The interface device 403 may be a headphone jack, a USB interface, and the like.

The input device 404 may be a touch screen, a button, and the like.

The display device 405 may be a liquid crystal display, a touch display, and the like.

The above embodiments mainly focus on the differences relative to other embodiments. Those skilled in the art should clearly understand that the above embodiments may be applied individually or in combination.

The embodiments presented herein are described in a progressive manner emphasizing the differences of each embodiment from the other embodiments, and reference may be made between the embodiments for their same or similar features. Since the apparatus embodiment substantially corresponds to the method embodiment, its description is relatively simple, and the relative parts may be referred to the description of the method embodiment. The apparatus embodiment described above is merely illustrative. The modules described above as a separate member may be, or may not be, physically separated.

The present disclosure may be implemented as a system, a method, and/or a computer program product. The computer program product may include a computer readable storage medium (or media) having computer readable program instructions thereon for causing a processor to carry out the aspects of the present disclosure.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers and/or edge servers. A network adapter card or network interface in each computing/processing device receives the computer readable program instructions from the network and forwards the computer readable program instructions for storage in a computer readable storage medium within the respective computing/processing device.

Computer readable program instructions for carrying out the operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform the aspects of the present disclosure.

Various aspects of the present disclosure are described in reference with the flow chart and/or block diagram of the method, apparatus (system) and computer program product according to the embodiments of the present disclosure. It should be understood that each block in the flow chart and/or block diagram and any combinations of the blocks in the flow chart and/or block diagram may be implemented by the computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create a means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement the aspects of the functions/acts specified in the flowchart and/or block diagram block or blocks.

The computer readable program instructions may also be loaded onto a computer, other programmable data processing apparatus, or other device to cause a series of operational steps to be performed on the computer, other programmable data processing apparatus, or other device to produce a computer implemented process, such that the instructions which execute on the computer, the other programmable data processing apparatus, or the other device implement the functions/acts specified in the flowchart and/or block diagram block or blocks.

The accompanying flow chart and block diagram present possible architecture, functions and operations realized by the system, method and computer program product according to a plurality of embodiments of the present disclosure. At this point, each block in the flow chart or block diagram may represent a module, a program segment, or a portion of the instruction. The module, the program segment or the portion of the instruction includes one or more executable instructions for implementing specified logic functions. In some alternative implementations, the function indicated in the block may also occur in an order different from the one represented in the drawings. For example, two consecutive blocks actually may be executed substantially in parallel, and sometimes they may also be executed in a reverse order, depending on the involved functions. It should also be noted that each block in the block diagram and/or flow chart, and any combinations of the blocks in the block diagram and/or flow chart may be implemented by a dedicated hardware-based system for implementing specified functions or actions, or a combination of the dedicated hardware and the computer instructions. It is well known to those skilled in the art that the implementation by hardware, the implementation by software, and the implementation by a combination of software and hardware are equivalent.

Various embodiments of the present disclosure have been described above, and the above explanation is illustrative rather than exhaustive and is not limited to the disclosed embodiments. Without departing from the scope and spirit of each explained embodiment, many alterations and modifications are obvious for those ordinary skilled in the art. The selection of the terms in the text aims to best explain the principle, actual application or technical improvement in the market of each embodiment or make each embodiment disclosed in the text comprehensible for those ordinary skilled in the art. The protection scope of the present disclosure should be determined by the appended claims.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. A method for upgrading an electronic device via a USB, comprising:
receiving an upgrade instruction;
controlling the electronic device to switch from a normal mode to a preparing-for-upgrade mode according to the upgrade instruction;
detecting whether the electronic device has established a connection to a computer through a USB data line, and if yes, receiving an upgrade confirmation instruction sent by the computer through the USB data line, and controlling the electronic device to switch from the preparing-for-upgrade mode to an upgrade mode and perform upgrade; and if no, controlling the electronic device to switch back to the normal mode from the preparing-for-upgrade mode.

2. The method according to claim 1, wherein the step of controlling the electronic device to switch from the preparing-for-upgrade mode to an upgrade mode and perform upgrade comprises:
controlling the electronic device to download upgrade data through the USB data line; and
upgrading the electronic device according to the completely downloaded upgrade data.

3. The method according to claim 2, wherein after the step of upgrading the electronic device according to the completely downloaded upgrade data, the method further comprises:
controlling the electronic device to switch back to the normal mode from the upgrade mode.

4. The method according to claim 2, further comprising:
in the process of downloading upgrade data through the USB data line, detecting whether the electronic device is establishing a connection to the computer through a USB data line, and if no, pausing the downloading.

5. An apparatus for upgrading an electronic device via a USB, comprising:
a first receiving module for receiving an upgrade instruction;
a first controlling module for controlling the electronic device to switch from a normal mode to a preparing-for-upgrade mode according to the upgrade instruction;
a first detecting module for detecting whether the electronic device has established a connection to a computer through a USB data line;
a second receiving module for receiving an upgrade confirmation instruction sent by the computer through the USB data line when the electronic device has established a connection to a computer through a USB data line;
a second controlling module for controlling the electronic device to switch from the preparing-for-upgrade mode to an upgrade mode and perform upgrade after the second receiving module receives the upgrade confirmation instruction; and
a third controlling module for controlling the electronic device to switch back to the normal mode from the preparing-for-upgrade mode when the electronic device does not establish a connection to a computer through a USB data line.

6. The apparatus according to claim 5, wherein the second controlling module comprises:
a downloading unit for controlling the electronic device to download upgrade data through the USB data line; and
an upgrading unit for upgrading the electronic device according to the upgrade data completely downloaded by the downloading unit.

7. The apparatus according to claim 6, further comprising:
a fourth controlling module for, after upgrading the electronic device by the upgrading unit, controlling the electronic device to switch back to the normal mode from the upgrade mode.

8. The apparatus according to claim 6, further comprising:
a second detecting module for, in the process that the downloading unit controls the electronic device to download upgrade data through the USB data line, detecting whether the electronic device is establishing a connection to the computer through a USB data line, and if no, pausing the downloading.

9. (canceled)

10. An electronic device, comprising a memory for storing instructions and a processor for operating the instructions to implement the following steps:
receiving an upgrade instruction;
controlling the electronic device to switch from a normal mode to a preparing-for-upgrade mode according to the upgrade instruction;
detecting whether the electronic device has established a connection to a computer through a USB data line, and if yes, receiving an upgrade confirmation instruction sent by the computer through the USB data line, and controlling the electronic device to switch from the preparing-for-upgrade mode to an upgrade mode and perform upgrade; and if no, controlling the electronic device to switch back to the normal mode from the preparing-for-upgrade mode.

11. The electronic device according to claim 10, wherein the step of controlling the electronic device to switch from the preparing-for-upgrade mode to an upgrade mode and perform upgrade comprises:
controlling the electronic device to download upgrade data through the USB data line; and
upgrading the electronic device according to the completely downloaded upgrade data.

12. The electronic device according to claim 11, wherein after the step of upgrading the electronic device according to the completely downloaded upgrade data, the processor further implement the step:
controlling the electronic device to switch back to the normal mode from the upgrade mode.

13. The electronic device according to claim 11, the processor further implement the step:
in the process of downloading upgrade data through the USB data line, detecting whether the electronic device is establishing a connection to the computer through a USB data line, and if no, pausing the downloading.
